(19) United States
(12) Patent Application Publication
(10) Pub. No.: US 2022/0118317 A1
(43) Pub. Date: Apr. 21, 2022

(54) Tennis Ball Storage

(71) Applicant: Tony Li-Wei Chang, Redding, CA (US)

(72) Inventor: Tony Li-Wei Chang, Redding, CA (US)

(21) Appl. No.: 17/071,764

(22) Filed: Oct. 15, 2020

(51) Int. Cl. A63B 39/02; B62B 3/00; A63B 47/00; B62B 3/10; A63B 39/00; A63B 102/02

(52) U.S. Cl. CPC A63B 39/025; B62B 3/002; A63B 47/00; A63B 2102/02; B62B 2202/40; A63B 2039/006; B62B 3/10

(57) ABSTRACT

A bag for storing tennis balls has an hermetic enclosure formed of flexible material, an opening larger than a tennis ball into the enclosure, the opening having a hermetic sealing zipper by which the opening may be opened and closed, and a flexible tubing from outside the enclosure through the flexible material, the flexible tubing having an open end adapted to engage an air pump, and a one-way valve adapted to admit air into the enclosure and to prevent air from exiting the enclosure through the tubing. Tennis balls placed into the bag are placed under pressure higher than the pressure inside a tennis ball by closing the opening by closing the hermetic sealing zipper, engaging an air pump to the open end of the flexible tubing, and operating the air pump until a predetermined pressure is established in the bag.

### BACKGROUND OF THE INVENTION

### 1. Field of the Invention

The present invention is in the technical area of apparatus supporting sports and games and pertains more particularly to apparatus for storing tennis balls between uses.

### 2. Description of Related Art

It is well known in the art that a substantial number of tennis balls are produced and used around the world, and that there are many enterprises where tennis is taught and practiced. In these enterprises typically an instructor may provide a substantial number of tennis balls to students and other players at a time of instruction and practice, and when a session is ended the tennis balls may be gathered up and stored until another session is scheduled.

It is less well known that tennis balls are produced with a positive pressure inside to provide a best physical response to being hit with a tennis racket or to striking a surface. Tennis balls are usually pressurized to 12 psi (pounds per square inch) more than normal air pressure. Normal air pressure is 14.7 psi, therefore pressure inside tennis balls is 26.7 psi. Tennis balls are sold in pressure cans, wherein the pressure is the same as the pressure inside of tennis ball. Tennis balls outside the can tend to decrease in pressure.

There are in the conventional art storage containers commercially available in which a certain number of tennis balls may be stored under pressure, so there may be no deterioration of pressure in the balls during storage time. It is known that many of these containers and peripheral apparatus are very expensive, and do not store a large number of balls.

What is needed is a system for deployment of tennis balls in instruction and practice sessions that handles a large enough number of balls for most sessions, and that also stores the balls between sessions under a pressure at least the pressure inside the balls. The system needed must also be relatively inexpensive.

### BRIEF SUMMARY OF THE INVENTION

In one embodiment of the present invention a bag for storing tennis balls is provided, comprising an hermetic enclosure formed of flexible material, an opening larger than a tennis ball into the enclosure, the opening having a hermetic sealing zipper by which the opening may be opened and closed, and a flexible tubing from outside the enclosure through the flexible material, the flexible tubing having an open end adapted to engage an air pump, and a one-way valve adapted to admit air into the enclosure and to prevent air from exiting the enclosure through the tubing. Tennis balls placed into the bag are placed under pressure higher than the pressure inside a tennis ball by closing the opening by closing the hermetic sealing zipper, engaging an air pump to the open end of the flexible tubing, and operating the air pump until a predetermined pressure is established in the bag.

In one embodiment the enclosure is formed in a rectangular shape approximating shape of a basket of a rolling cart, such that the bag is enabled to be placed in the basket and rolled to different places on a tennis court. Also, in one embodiment the bag comprises a top panel joined to sides and ends of the bag around three sides by the hermetic sealing zipper. In one embodiment the bag further comprises two handles implemented on opposite sides of the bag each near a top extremity of the sides of the bag. And in one embodiment one or more of side, end or top panels are reinforced with semi-rigid panels within the side, end or top panels.

In another aspect of the invention a system for managing tennis balls in playing sessions on a tennis court is provided, comprising a bag for storing the tennis balls, having an hermetic enclosure formed of flexible material, an opening larger than a tennis ball into the enclosure, the opening having a hermetic sealing zipper by which the opening may be opened and closed, and a flexible tubing from outside the enclosure through the flexible material, the flexible tubing having an open end adapted to engage an air pump, and a one-way valve adapted to admit air into the enclosure and to prevent air from exiting the enclosure through the tubing, and a rolling cart having a basket with overall dimensions larger than overall dimensions of the bag, such that the bag may be placed in the basket of the cart.

In one embodiment of the system tennis balls are stored in the bag under pressure higher than the pressure inside a tennis ball by opening the hermetic sealing zipper, placing tennis balls in the bag, closing the hermetic sealing zipper and pressurizing the bag by operating an air pump engaged to the open end of the flexible tubing. Also, in one embodiment of the system the enclosure is formed in a rectangular shape approximating shape of a the basket of the cart, such that the bag is enabled to be placed in the basket and rolled to different places on a tennis court. In one embodiment the bag comprises a top panel joined to sides and ends of the bag around three sides by the hermetic sealing zipper. And in one embodiment the bag further comprises two handles implemented on opposite sides of the bag each near a top extremity of the sides of the bag. In one embodiment of the system one or more of side, end or top panels are reinforced with semi-rigid panels within the side, end or top panels.

In yet another aspect of the system a method for providing tennis balls in practice and playing sessions is provided, comprising carrying a bag for storing tennis balls under pressure to a place on a tennis court, the bag providing an hermetic enclosure formed of flexible material, an opening larger than a tennis ball into the enclosure, the opening having a hermetic sealing zipper by which the opening may be opened and closed, and a flexible tubing from outside the enclosure through the flexible material, the flexible tubing having an open end adapted to engage an air pump, and a one-way valve adapted to admit air into the enclosure and to prevent air from exiting the enclosure through the tubing, opening the bag by opening the hermetic sealing zipper, and providing tennis balls from the bag to players on the tennis court.

In one embodiment the method further comprises gathering the tennis balls after a session and replacing the balls in the bag, closing the hermetic sealing zipper, connecting an air pump to the open end of the flexible tubing, and operating the air pump, placing he tennis balls under a pressure higher than the pressure inside a tennis ball. Also, in one embodiment the method further comprises placing the bag into a basket of a rolling cart and delivering the bag with the tennis balls to the place on the tennis court by rolling the cart to the place. In one embodiment the bag is formed in the shape of the basket, and has a top panel joined to sides and ends of the bag by the hermetic sealing zipper around three sides of the bag. In one embodiment the method further comprises two handles implemented on opposite sides of the bag each near a top extremity of the sides of the bag. And in one embodiment one or more of side, end or top panels are reinforced with semi-rigid panels within the side, end or top panels.

### BRIEF DESCRIPTION OF THE SEVERAL VIEWS OF THE DRAWINGS

FIG. 1 is a perspective view of a tennis ball cart that is known to be used for distributing tennis balls in instruction and practice sessions.

FIG. 2A depicts a tennis ball bag for storing tennis balls under pressure in an embodiment of the present invention.

FIG. 2B illustrates an opening in the tennis ball bag of FIG. 2A, with a one-way valve for pressurizing the bag.

FIG. 2C illustrate another opening into the tennis ball bag for deflating the bag.

FIG. 3 is a perspective view of the bag of FIG. 2 suspended over the tennis ball cart of FIG. 1.

FIG. 4 is a perspective view of the bag of FIG. 3 lowered into and supported by the basket of the cart of FIGS. 1 and 3.

FIG. 5 is a perspective view of the bag of FIG. 4 in the cart of FIG. 4, with the zipper open and the top folded open down one side of the basket.

FIG. 6 is a flow diagram depicting steps in a process of deploying, using and storing tennis balls in an embodiment of the invention.

### DETAILED DESCRIPTION OF THE INVENTION

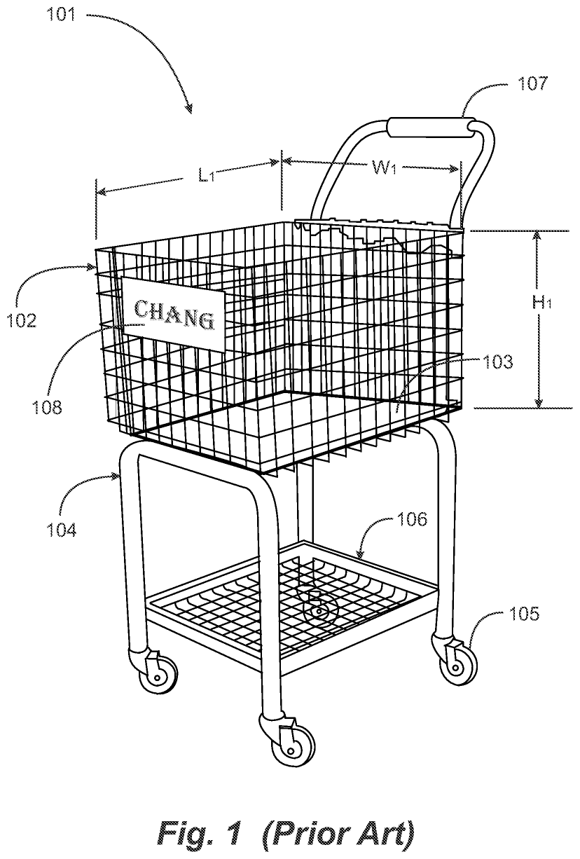

FIG. 1 is a perspective view of a tennis ball cart 101 that is known to be used for distributing tennis balls in instruction and practice sessions. Cart 101 has a basket 102 having four sides and a bottom 103, open at the top. Basket 102 is supported on a carriage 104 that has casters 105 in this example such that the carriage may be wheeled around a tennis court by a handle 107 to provide and gather balls where needed. There may in some circumstances be a lower tray 106 which may be used to carry peripheral apparatus. There may in addition be a plaque 108 that may be used to identify the cart or the enterprise to which the cart belongs, for example. The plaque may display a logo or a name.

In this example basket 102 has a length L₁, a width W₁ and a height H₁. In one example W₁ and L₁ may be as much as two feet or more, and height H₁ may be as much as 18 inches or more. Dimensions in different carts may vary widely, but it is desirable that the volume W₁×L₁×H₁ be large enough to carry a substantial number of tennis balls. In some circumstances basket 102 may have a removable or a hinged lid which, in embodiments of the invention may be removed or opened.

In the conventional art carts like that depicted in FIG. 1 are used at tennis courts and in instruction and practice sessions. The cart is filled at least partially with tennis balls from some other apparatus where balls are stored, and the cart may be moved around by a user and tennis balls may be dispensed from the cart. Tennis balls may also be gathered up and returned to the cart. After a session is ended the tennis balls are typically removed from the cart and returned to a storage device that may or may not store the balls under pressure.

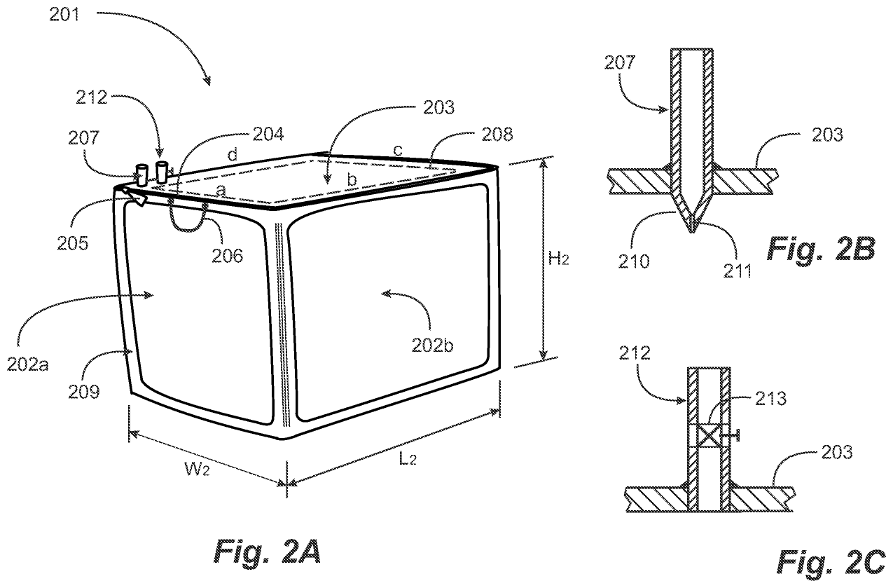

FIG. 2A illustrates a tennis ball bag 201 for storing tennis balls under pressure according to an embodiment of the present invention. Bag 201 in one embodiment is made to be essentially the size and the shape of basket 102 of cart 101 of FIG. 1, as a purpose of the invention is for the bag is to be placed in the basket. The overall dimensions of bag 201 are shown as L₂, W₂ and H₂, which dimensions may be just a bit smaller than the corresponding dimensions of basket 102 of FIG. 1, allowing an easy fit of bag 201 into basket 102.

Bag 201 is constructed, as shown, in this example in a substantially rectangular form, having two end panels, such as end panel 202a, two sides panels, such as side panel 202b, a top panel 203 and a bottom panel not seen in FIG. 2A. The material of the panels is in one embodiment a fabric impregnated with rubber, synthetic rubber, or a rubber-like polymer, such that the panels will not pass either gas or liquid. The panels may be joined along edges into the rectangular shape by a suitable sealing process depending on material used, such that the joined edges are also resistant to passage of gas or liquid. In one embodiment edges may be reinforced by fabric strips 209 joined to the panels by a strong adhesive.

In an alternative embodiment the body of bag 201 may be molded of a rubber-like material into the needed shape with controlled wall thickness, avoiding a necessity of joining separate panels. In one embodiment one or more of the panels of the bag may be reinforced by molding a more rigid panel within the more flexible rubber-like panel, such that panels thus reinforced will not expand under pressure as much as they might without reinforcement. A bag with reinforced panels will maintain the substantially rectangular shape more readily. Top panel 203 is shown in FIG. 2A with a reinforcement panel 208 molded in.

Top panel 203 in this example is joined to one side and the ends of bag 201 by a zipper 204 capable of an hermetic seal, of which there are a considerable variety commercially available at the time of filing of this patent application. Some such zippers are available that may be heat sealed to polymer side materials. Zipper 204 around three sides enables the top to be opened and folded over one side of the rectangular structure.

In this example a tube 207 from outside to inside of the bag is provided with a one-way valve, such that air or another gas may be pumped by a manual or a powered pump through the tube and into the bag to increase pressure in the bag, and as the pressure in the bag will close the one-way valve, the pressure will be maintained when the pump is removed from the tube. A second tube 212 is also provided with a manually operable valve to depressurize the bag. Tubes 207 and 212 are shown implemented near one edge of the bag. The tubes may, however, be implemented in other embodiment just about anywhere on the bag.

In one embodiment bag 201 may be labeled on a side or top panel of the bag as a “Pressurized Tennis Ball Storage Bag”.

FIG. 2B is a magnified section view of tube 207 in one example. A conduit from a hand-operated or a powered pump may be engaged in the open end of tube 207 and operated to pump air into the bag with the top panel closed by the sealed zipper. End 210 of tube 207 is tapered as shown, and a small diameter opening 211 allows air to be pumped into the bag. Opening 211 expands under pressure of air in the tube when a pump is operated and closes by back pressure of air in the bag when the pump is not operated or is removed.

FIG. 2C illustrates another opening into the bag comprising a tube 212 having a manually operable valve 213, which a user may open to depressurize the bag. Manually operable valve 213 is shown diagrammatically, rather than specifically, as there are a variety of commercially available manually operable valves that may be used. For example, the manually operable valve may be as simple as a spring-loaded pinch device, like a binder clip, that may be used to close and open tube 212. Valve 213 may preferably be built into tube 212 with a lever or dial that may be used to open and close the inside passage of tube 212.

In this example there are two handles 206 implemented at an upper extremity of each of the end panels to aid a user in handling bag 201. In this example the handles are cord or cable attached at ends near a midpoint of each of the end panels. In other embodiments handles may be the long side of the bag, and may extend to the ends. There are also other ways that handles may be implemented.

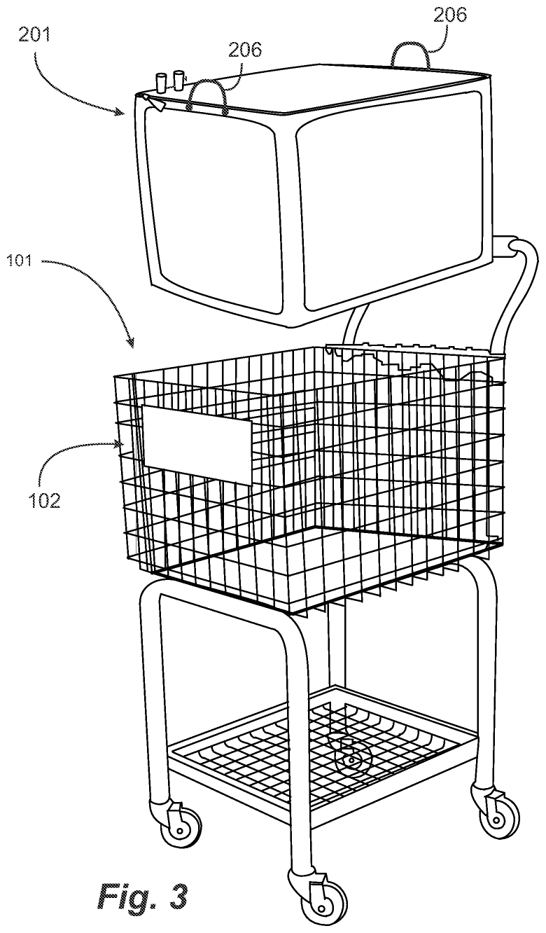

FIG. 3 is a perspective view of the bag of FIG. 2 suspended over the tennis ball cart of FIG. 1. Handles 206 are shown on the ends of the bag inverted as they might be if the bag were being suspended by the handles. This view illustrates the spatial relationship of bag 201 when and if the bag is in process of being removed from or placed into basket 102 of cart 101.

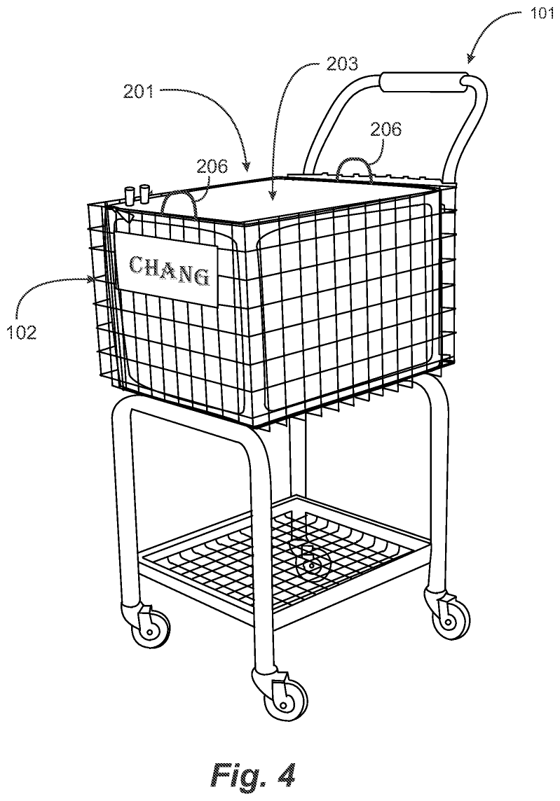

FIG. 4 is a perspective view of bag 201 lowered into and supported by basket 102 of cart 101. Handles 206 are still shown as extending upward. Top panel 203 is closed with the zipper fully closed and sealing the top panel to the side and end panels. In this aspect, with bag 201 holding tennis balls, the supply of balls may be moved where needed on tennis courts.

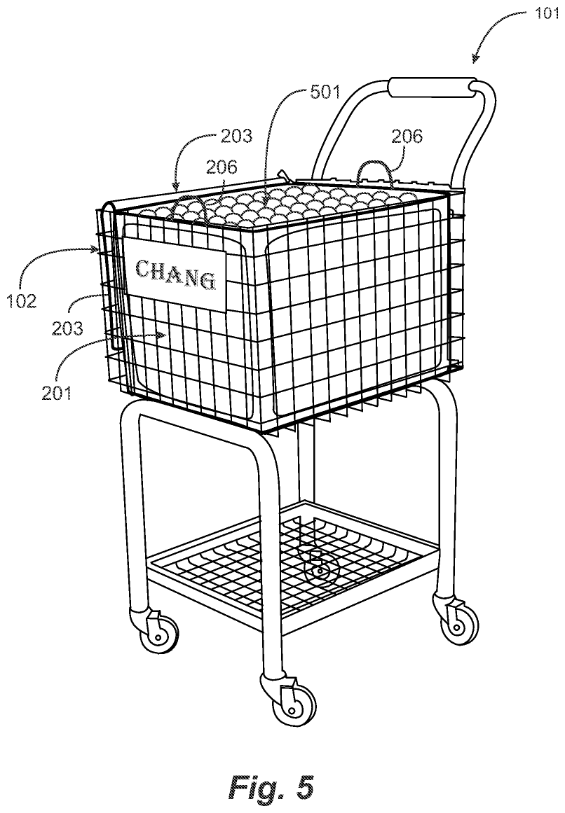

FIG. 5 is a perspective view of bag 201 in basket 102 of cart 101 with the zipper open and top 203 folded open down one side of basket 102. The bag is shown in this example filled with tennis balls 501. As described above, cart 101 may be rolled around a tennis court and tennis balls may be delivered out of the bag, and at the end of a session may be gathered and returned to the bag.

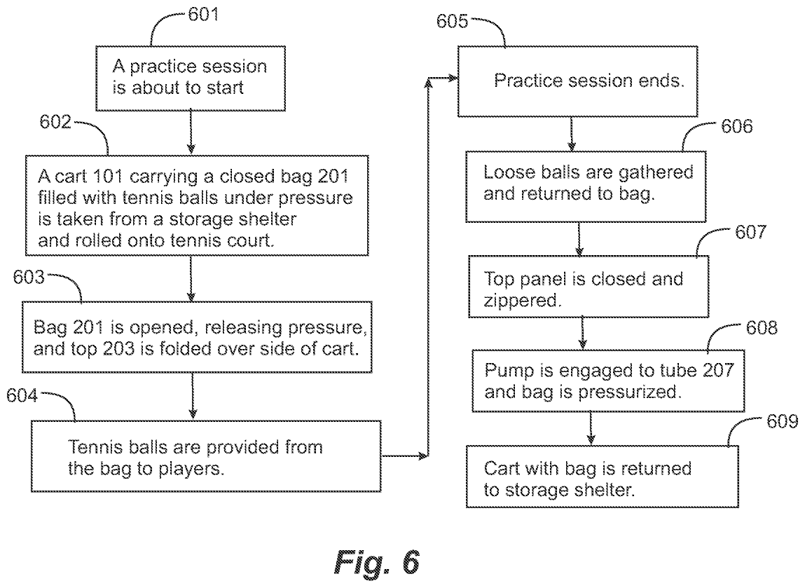

FIG. 6 is a flow diagram depicting steps in a process of deploying, using a storing tennis balls in an embodiment of the invention. At step 601 a practice session at a tennis court is about to start. At step 602 a cart carrying a closed and pressurized bag is taken from a storage shelter and rolled onto the tennis court. Under a different circumstance the bag may be brought to the tennis court, such as in an automobile, and placed into the cart. At step 603 the bag is opened, releasing pressure in the bag, ad a top of the bag is folded over a side of the cart. At step 604 tennis balls are provided to players to be used in the practice session. At step 605 the practice session ends. At step 606 loose balls are retrieved and replaced in the bag in the cart. At step 607 the top panel is closed, and the sealing zipper is closed. At step 608 an air pump is engaged to tube 207 and the bag is pressurized to a predetermined pressure which may be monitored on a pressure gauge as a part of the air pump. At step 609 the cart is returned to the storage shelter to be available later for another practice session. In another circumstance the bag may be taken from the cart, placed in a vehicle, and may be taken away, to be brought back for another session, or taken to a different court for a different session.

A person with skill in the art will understand that the embodiments described above are entirely exemplary, and there may be variations in many variables, but still within the scope of the invention. For example, it is not required to practice the invention that the bag be shaped to the shape of the basket of the cart. The bag may take essentially any shape as long as when pressurized, the bag may be placed into the basket of the cart without interference. In one embodiment the cart may not be used at all, and the bag may simply be carried by the handles to where tennis balls are needed o the tennis court.

Further to the above, the zipper is not limited to three sides of the bag, but may be implemented in other ways. There are similarly many other variations that may be made within the scope of the invention. The invention is limited only by the claims.

1. A bag for storing tennis balls, comprising:
a hermetic enclosure having four sides, a bottom, and a top the sides, the bottom, and the top formed of flexible, hermetic material;
semi-rigid reinforcement panels of lesser length and width than a length and width of each of the sides, the bottom and the top and molded within the sides, the bottom and the top, providing structural integrity the sides joined along vertical edges to one another and along horizontal edges to the bottom by flexible hermetic material;
a hermetic sealing zipper implemented along three of the sides at an upper extremity and along three sides of the top, such that the top is fully opened and closed by opening and closing the hermetic sealing zipper;
a first tubing sealed through the top, the first tubing having an open end adapted to engage an air pump, and a one-way valve adapted to admit air into the hermetic enclosure and to prevent air from exiting the hermetic enclosure through the first tubing;
a second tubing sealed through the top, the second tubing having a manually operable valve, closed to pressurize the hermetic enclosure, and open to exhaust the hermetic enclosure; and
two handles implemented midway along two opposite sides, at an upper extremity of the sides.

2-5. (canceled)

6. A system for managing tennis balls in playing sessions on a tennis court, comprising:
a wheeled cart having a frame with wheels and a rigid basket having four substantially vertical sides, a bottom and an open top, the rigid basket having a length L1, a width W1 and a height H1, the rigid basket supported in the frame with the open top in a horizontal plane; and
a bag for storing tennis balls, comprising a hermetic enclosure having four rectangular sides, a bottom, and a top the sides, bottom, and the top formed of flexible, hermetic material;
semi-rigid reinforcement panels of lesser length and width than a length and width of each of the sides, the bottom and the top and molded within the sides, the bottom and the top, providing structural integrity the sides joined along vertical edges to one another and along horizontal edges to the bottom by flexible hermetic material;
a hermetic sealing zipper implemented along three of the sides at an upper extremity and along three sides of the top, such that the top may be opened and closed by opening and closing the hermetic sealing zipper;
a first tubing sealed through the top, the first tubing having an open end adapted to engage an air pump, and a one-way valve adapted to admit air into the hermetic enclosure and to prevent air from exiting the hermetic enclosure through the first tubing;
a second tubing sealed through the top, the second tubing having a manually operable valve, closed to pressurize the hermetic enclosure, and open to exhaust the hermetic enclosure; and
two handles implemented midway along two opposite sides, at an upper extremity of the opposite sides, the bag having a length L2, a width W2 and a height H1;
wherein each of L1 and W1 are nominally larger than L2 and W2 such that the bag supported by the two handles, lowered into the rigid basket, is supported by the bottom and sides of the rigid basket, with the top of the bag even with the open top of the rigid basket.

7. The system of claim 6 wherein tennis balls are stored in the bag under pressure higher than the pressure inside the tennis balls by opening the hermetic sealing zipper, placing the tennis balls in the bag, closing the hermetic sealing zipper and pressurizing the bag by operating an air pump engaged to the open end of the first tubing.

8-11. (canceled)

12. A method for providing tennis balls with positive internal pressure in practice and playing sessions, comprising:
placing a bag storing tennis balls under pressure into a wheeled cart having a frame with wheels and a rigid basket having four substantially vertical sides, a bottom and an open top, the basket having a length L1, a width W1 and a height H1, the basket supported in the frame with the open top in a horizontal plane, the bag in the basket supported by the bottom of the basket with the top of the bag even with the open top of the rigid basket, the bag comprising a hermetic enclosure having four rectangular sides, a bottom, and a top, the sides, bottom, and the top formed of flexible, hermetic material semi-rigid reinforcement panels of lesser length and width of a length and width of each of the molded within, providing structural integrity; the sides joined along vertical edges to one another and along horizontal edges to the bottom by flexible hermetic material;
a hermetic sealing zipper implemented along three of the sides at an upper extremity and along three sides of the top, such that the top may be opened and closed by opening and closing the hermetic sealing zipper;
a first tubing sealed through the top, the first tubing having an open end adapted to engage an air pump, and a one-way valve adapted to admit air into the hermetic enclosure and to prevent air from exiting the hermetic enclosure through the first tubing, a second tubing sealed through the top, the second tubing having a manually operable valve, closed to pressurize the hermetic enclosure, and open to exhaust the hermetic enclosure, and two handles implemented midway along two opposite sides, at an upper extremity of the sides, the bag having a length L2, a width W2 and a height H1;
deflating the bag by opening the manually operable valve in the second tube;
opening the bag by opening the hermetic sealing zipper and folding the top of the bag to one side; and
providing tennis balls from the bag to players on a tennis court.

13-17. (canceled)
